(19) United States
(12) Patent Application Publication
(10) Pub. No.: US 2025/0324411 A1
(43) Pub. Date: Oct. 16, 2025

(54) DOWNLINK SEMI-PERSISTENT SCHEDULING OPPORTUNITY SKIPPING

(71) Applicant: QUALCOMM Incorporated, sAN dIEGO, CA (US)

(72) Inventors: Zhichao ZHOU, Beijing (CN); Ahmed ELSHAFIE, San Diego, CA (US); Mickael MONDET, Louannec (FR); Yih-Hao LIN, San Diego, CA (US); Ravi AGARWAL, San Diego, CA (US); Diana MAAMARI, San Diego, CA (US); Huilin XU, Temecula, CA (US); Seyedkianoush HOSSEINI, San Diego, CA (US)

(21) Appl. No.: 18/865,911

(22) PCT Filed: Aug. 1, 2022
(86) PCT No.: PCT/CN2022/109370

§ 371 Date: Nov. 14, 2024

(51) Int. Cl. H04W 72/11; H04W 72/232

(52) U.S. Cl. CPC H04W 72/11; H04W 72/232

(57) ABSTRACT

Various aspects of the present disclosure generally relate to wireless communication. In some aspects, a user equipment (UE) may receive information indicating a skip of an upcoming semi-persistent scheduling (SPS) opportunity, of a set of configured SPS opportunities. The UE may monitor one or more SPS opportunities, of the set of SPS opportunities, other than the upcoming SPS opportunity based at least in part on receiving the information. Numerous other aspects are described.

### FIELD OF THE DISCLOSURE

Aspects of the present disclosure generally relate to wireless communication and to techniques and apparatuses for downlink semi-persistent scheduling opportunity skipping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving information indicating a skip of an upcoming semi-persistent scheduling (SPS) opportunity, of a set of configured SPS opportunities. The method may include monitoring one or more SPS opportunities, of the set of SPS opportunities, other than the upcoming SPS opportunity based at least in part on receiving the information.

Some aspects described herein relate to a method of wireless communication performed by a network node. The method may include transmitting, to a UE, information indicating a skip of an upcoming SPS opportunity, of a set of configured SPS opportunities. The method may include transmitting, in one or more SPS opportunities, of the set of SPS opportunities, other than the upcoming SPS opportunity based at least in part on transmitting the information.

Some aspects described herein relate to a UE for wireless communication. The UE may include a memory and one or more processors coupled to the memory. The one or more processors may be configured to receive information indicating a skip of an upcoming SPS, of a set of configured SPS opportunities. The one or more processors may be configured to monitor one or more SPS opportunities, of the set of SPS opportunities, other than the upcoming SPS opportunity based at least in part on receiving the information.

Some aspects described herein relate to a network node for wireless communication. The network node may include a memory and one or more processors coupled to the memory. The one or more processors may be configured to transmit, to a UE, information indicating a skip of an upcoming SPS opportunity, of a set of configured SPS opportunities. The one or more processors may be configured to transmit, in one or more SPS opportunities, of the set of SPS opportunities, other than the upcoming SPS opportunity based at least in part on transmitting the information.

Some aspects described herein relate to a non-transitory computer-readable medium that stores a set of instructions for wireless communication by a UE. The set of instructions, when executed by one or more processors of the UE, may cause the UE to receive information indicating a skip of an upcoming SPS opportunity, of a set of configured SPS opportunities. The set of instructions, when executed by one or more processors of the UE, may cause the UE to monitor one or more SPS opportunities, of the set of SPS opportunities, other than the upcoming SPS opportunity based at least in part on receiving the information.

Some aspects described herein relate to a non-transitory computer-readable medium that stores a set of instructions for wireless communication by a network node. The set of instructions, when executed by one or more processors of the network node, may cause the network node to transmit, to a UE, information indicating a skip of an upcoming SPS opportunity, of a set of configured SPS opportunities. The set of instructions, when executed by one or more processors of the network node, may cause the network node to transmit, in one or more SPS opportunities, of the set of SPS opportunities, other than the upcoming SPS opportunity based at least in part on transmitting the information.

Some aspects described herein relate to an apparatus for wireless communication. The apparatus may include means for receiving information indicating a skip of an upcoming SPS opportunity, of a set of configured SPS opportunities. The apparatus may include means for monitoring one or more SPS opportunities, of the set of SPS opportunities, other than the upcoming SPS opportunity based at least in part on receiving the information.

Some aspects described herein relate to an apparatus for wireless communication. The apparatus may include means for transmitting, to a UE, information indicating a skip of an upcoming SPS opportunity, of a set of configured SPS opportunities. The apparatus may include means for transmitting, in one or more SPS opportunities, of the set of SPS opportunities, other than the upcoming SPS opportunity based at least in part on transmitting the information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of downlink semi-persistent scheduling (SPS) communication, in accordance with the present disclosure.

FIG. 6 is a diagram illustrating an example of SPS communication, in accordance with the present disclosure.

FIGS. 7A and 7B are diagrams illustrating an example associated with downlink SPS opportunity skipping, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can in be applied to other RATs, such as a 3G RAT, a 4G RAT, and/or a RAT subsequent to 5G (e.g., 6G).

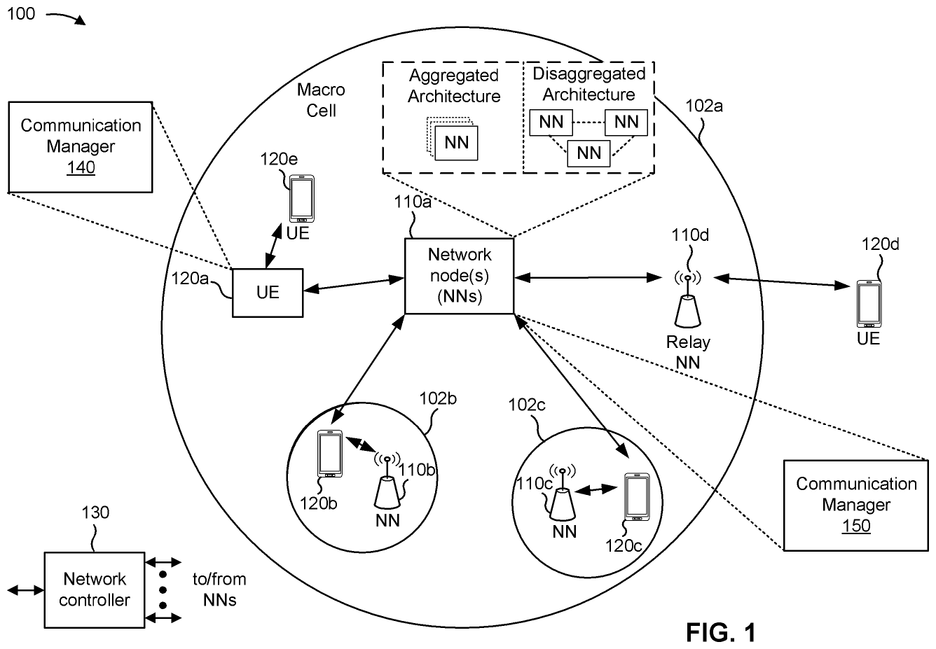

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information indicating a skip of an upcoming semi-persistent scheduling (SPS) opportunity, of a set of configured SPS opportunities; and monitor one or more SPS opportunities, of the set of SPS opportunities, other than the upcoming SPS opportunity based at least in part on receiving the information. Additionally, or alternatively, the communication manager 140 may perform one or more other operations described herein.

In some aspects, the network node 110 may include a communication manager 150. As described in more detail elsewhere herein, the communication manager 150 may transmit, to a UE, information indicating a skip of an upcoming SPS opportunity, of a set of configured SPS opportunities; and transmit, in one or more SPS opportunities, of the set of SPS opportunities, other than the upcoming SPS opportunity based at least in part on transmitting the information. Additionally, or alternatively, the communication manager 150 may perform one or more other operations described herein.

As indicated above, FIG. 1 is provided as an example. Other examples may differ from what is described with regard to FIG. 1.

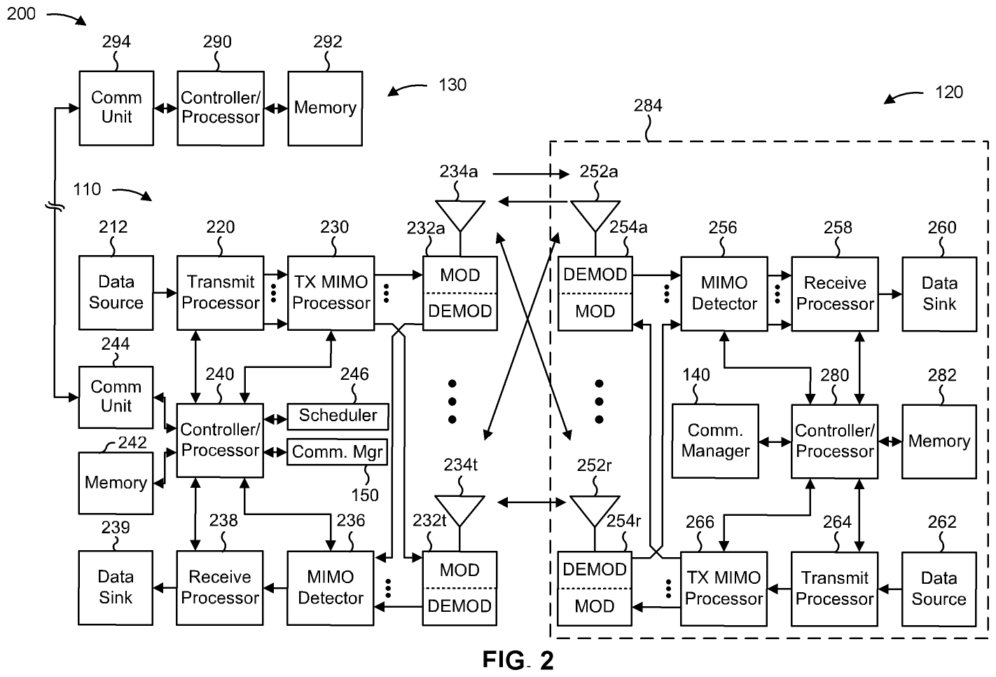

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

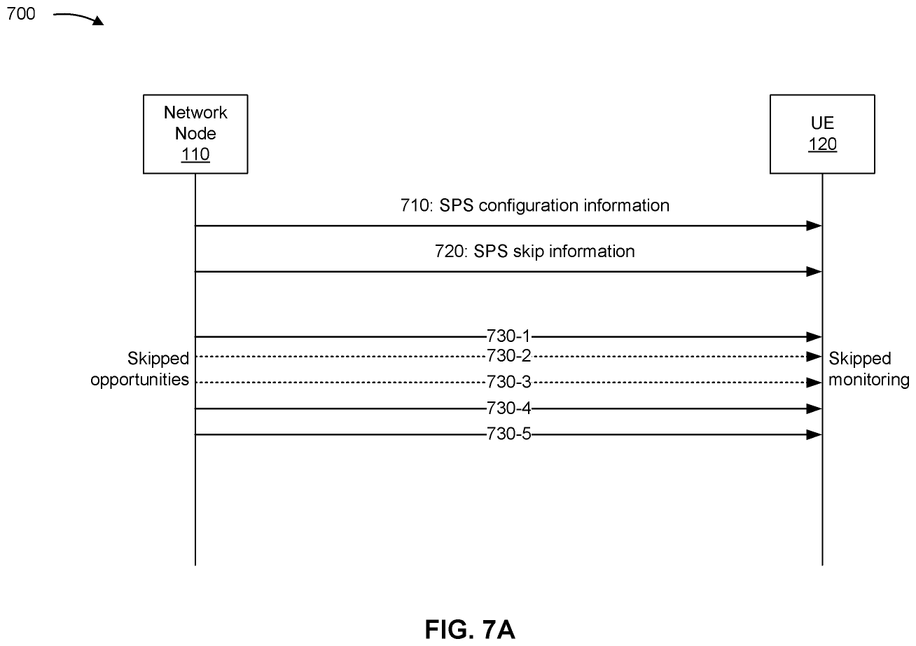

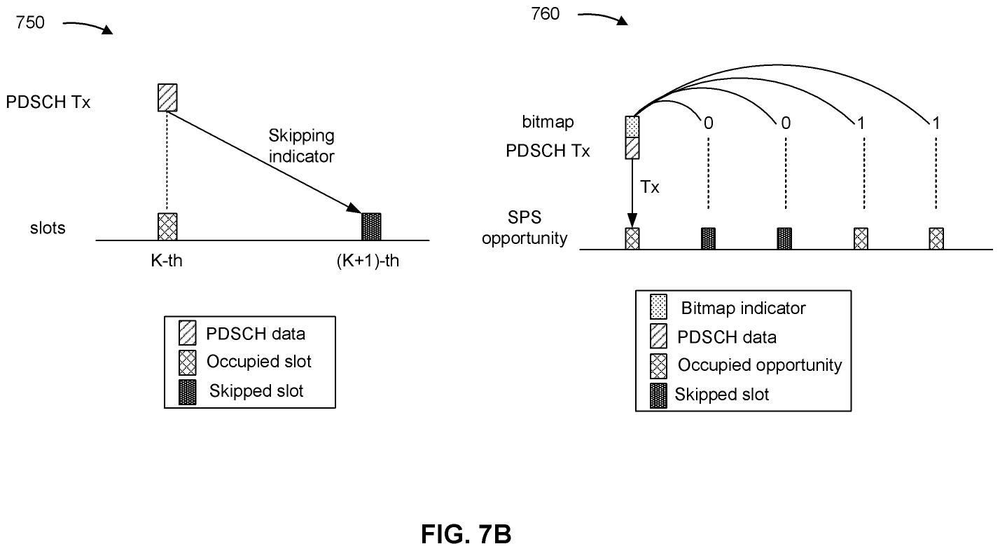

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-11).

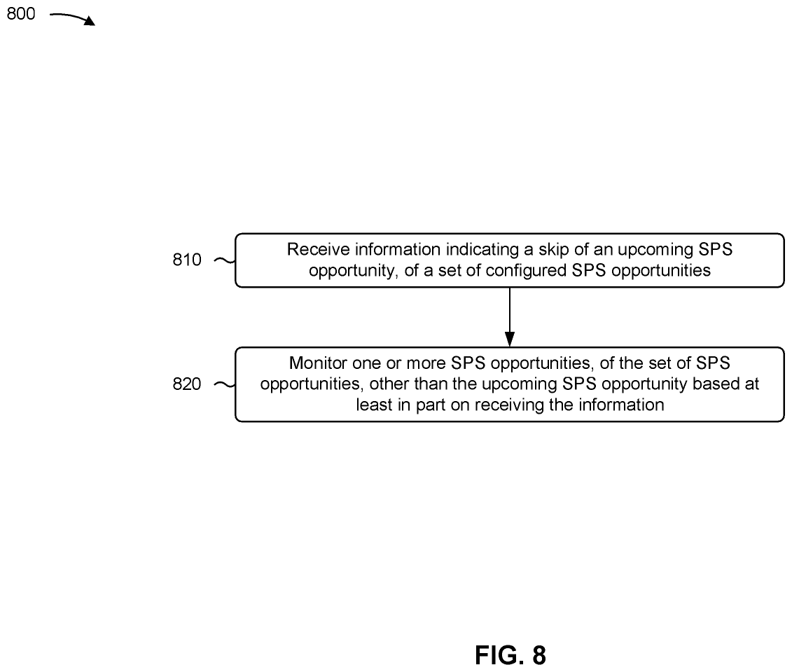

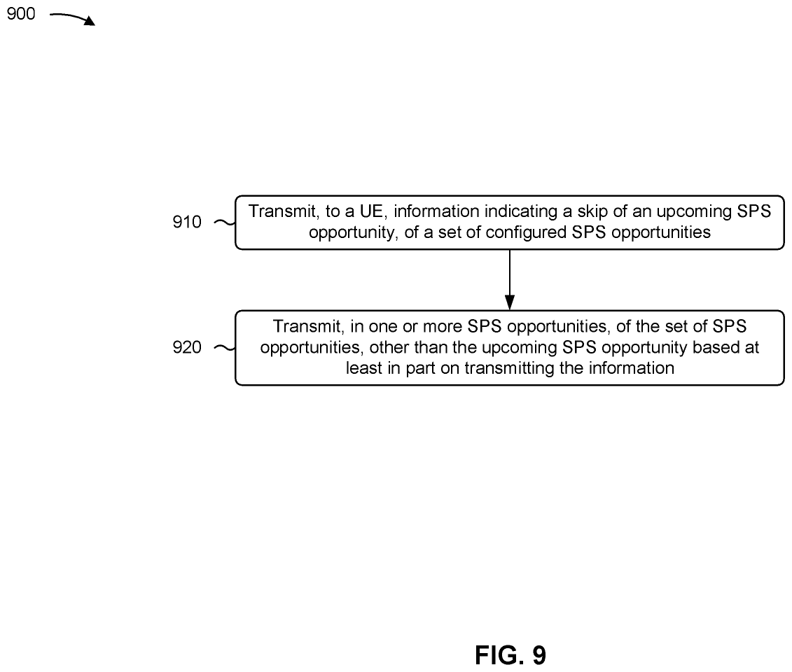

The controller/processor 240 of the network node 110, the controller/processor 280 of the UE 120, and/or any other component(s) of FIG. 2 may perform one or more techniques associated with downlink SPS opportunity skipping, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving information indicating a skip of an upcoming SPS opportunity, of a set of configured SPS opportunities; and/or means for monitoring one or more SPS opportunities, of the set of SPS opportunities, other than the upcoming SPS opportunity based at least in part on receiving the information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, information indicating a skip of an upcoming SPS opportunity, of a set of configured SPS opportunities; and/or means for transmitting, in one or more SPS opportunities, of the set of SPS opportunities, other than the upcoming SPS opportunity based at least in part on transmitting the information. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

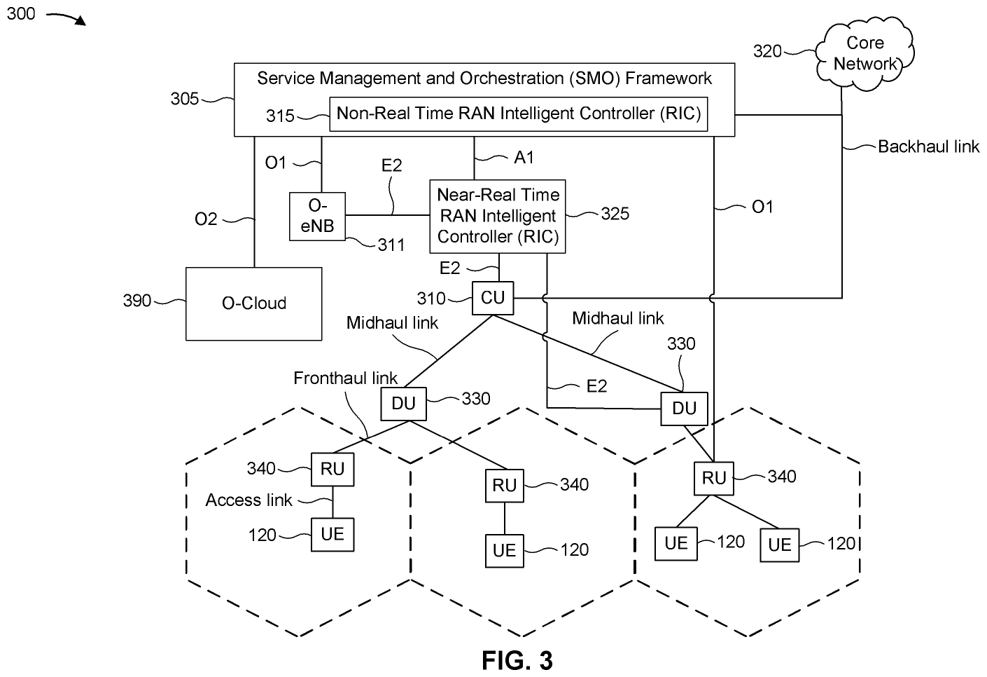

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

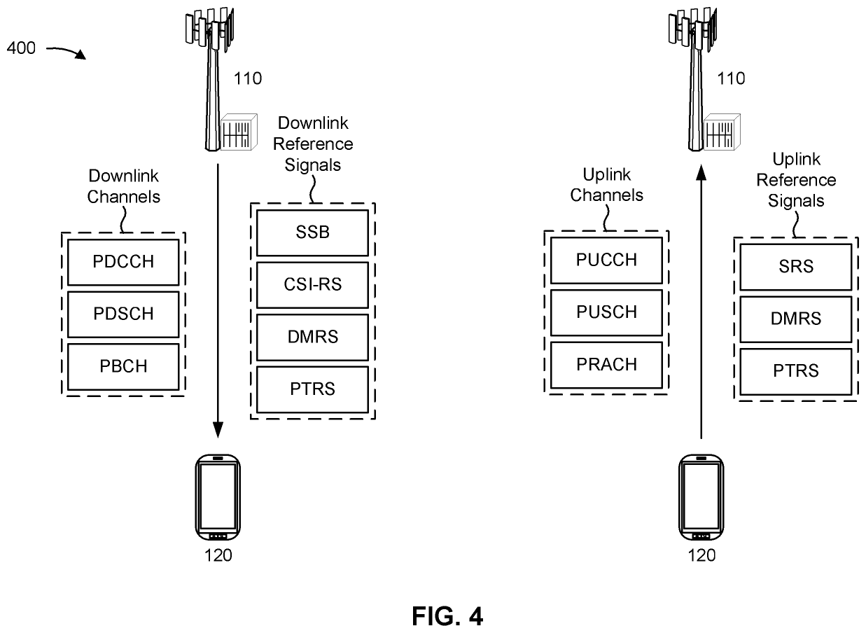

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

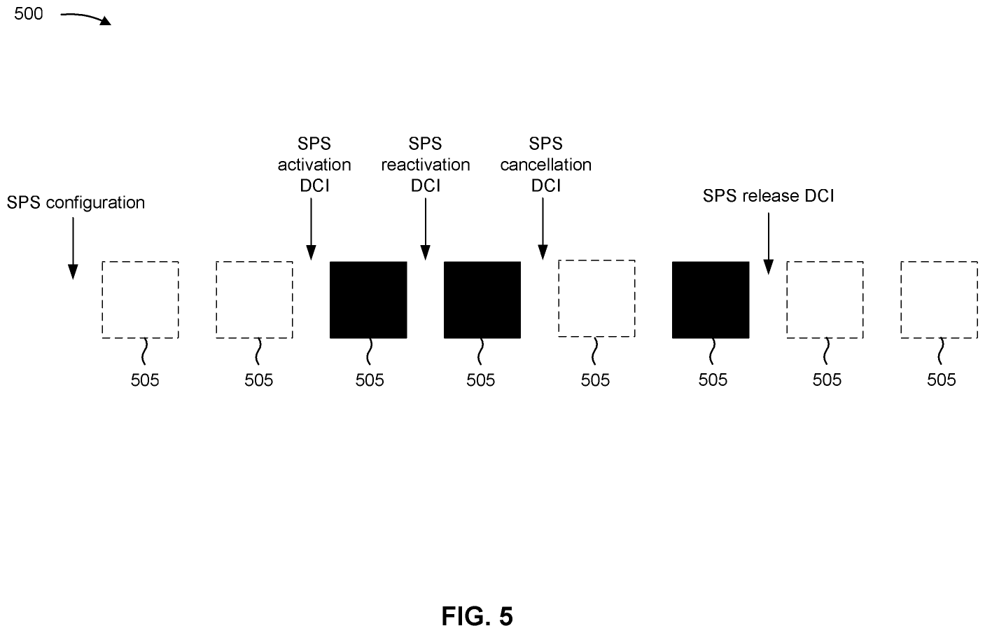

FIG. 5 is a diagram illustrating an example 500 of downlink SPS communication, in accordance with the present disclosure. SPS communications may include periodic downlink communications that are configured for a UE, such that a network node does not need to transmit (e.g., directly or via one or more network nodes) separate DCI to schedule each downlink communication, thereby conserving signaling overhead. One use case for periodic downlink communications is for extended reality (XR) traffic. In XR traffic use cases, downlink traffic is transmitted to a UE on a semi-periodic basis, so SPS scheduling may be appropriate for allocating resources for the semi-periodic downlink traffic.

As shown in example 500, a UE may be configured with an SPS configuration for SPS communications. For example, the UE may receive the SPS configuration via a radio resource control (RRC) message transmitted by a network node (e.g., directly or via one or more network nodes). The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions 505 for the UE. The SPS configuration may also configure hybrid automatic repeat request (HARQ)-acknowledgement (ACK) (HARQ-ACK) feedback resources for the UE to transmit HARQ-ACK feedback for SPS physical downlink shared channel (PDSCH) communications received in the SPS occasions 505. For example, the SPS configuration may indicate a PDSCH-to-HARQ feedback timing value, which may be referred to as a K1 value in a wireless communication standard (e.g., a 3GPP standard). In some cases, the network node may transmit DCI via a PDCCH with the PDSCH to convey control information to the UE. However, the network node may refrain from transmitting DCI via a PDCCH with some PDSCHs to reduce overhead, increase resource efficiency, and increase a communication capacity for other information. Moreover, the UE may have less information to de-modulate and process when DCI is omitted, and latency associated with decoding the PDSCH may be reduced when DCI is omitted. Accordingly, in XR use cases, which may be time-sensitive and power-limited, the network node may refrain from transmitting DCI in some of the SPS occasions.

The network node may transmit SPS activation DCI to the UE (e.g., directly or via one or more network nodes) to activate the SPS configuration for the UE. The network node may indicate, in the SPS activation DCI, communication parameters, such as an MCS, a resource block (RB) allocation, and/or antenna ports, for the SPS PDSCH communications to be transmitted in the scheduled SPS occasions 505. The UE may begin monitoring the SPS occasions 505 based at least in part on receiving the SPS activation DCI. For example, beginning with a next scheduled SPS occasion 505 subsequent to receiving the SPS activation DCI, the UE may monitor the scheduled SPS occasions 505 to decode PDSCH communications using the communication parameters indicated in the SPS activation DCI. The UE may refrain from monitoring configured SPS occasions 505 prior to receiving the SPS activation DCI.

The network node may transmit SPS reactivation DCI to the UE (e.g., directly or via one or more network nodes) to change the communication parameters for the SPS PDSCH communications. Based at least in part on receiving the SPS reactivation DCI, the UE may begin monitoring the scheduled SPS occasions 505 using the communication parameters indicated in the SPS reactivation DCI. For example, beginning with a next scheduled SPS occasion 505 subsequent to receiving the SPS reactivation DCI, the UE may monitor the scheduled SPS occasions 505 to decode PDSCH communications based on the communication parameters indicated in the SPS reactivation DCI.

In some cases, such as when there is not downlink traffic to transmit to the UE, the network node may transmit SPS cancellation DCI to the UE (e.g., directly or via one or more network nodes) to temporarily cancel or deactivate one or more subsequent SPS occasions 505 for the UE. The SPS cancellation DCI may deactivate only a subsequent one SPS occasion 505 or a subsequent N SPS occasions 505 (where N is an integer). SPS occasions 505 after the one or more (e.g., N) SPS occasions 505 subsequent to the SPS cancellation DCI may remain activated. Based at least in part on receiving the SPS cancellation DCI, the UE may refrain from monitoring the one or more (e.g., N) SPS occasions 505 subsequent to receiving the SPS cancellation DCI. As shown in example 500, the SPS cancellation DCI cancels one subsequent SPS occasion 505 for the UE. After the SPS occasion 505 (or N SPS occasions) subsequent to receiving the SPS cancellation DCI, the UE may automatically resume monitoring the scheduled SPS occasions 505.

The network node may transmit SPS release DCI to the UE (e.g., directly or via one or more network nodes) to deactivate the SPS configuration for the UE. The UE may stop monitoring the scheduled SPS occasions 505 based at least in part on receiving the SPS release DCI. For example, the UE may refrain from monitoring any scheduled SPS occasions 505 until another SPS activation DCI is received by the UE. Whereas the SPS cancellation DCI may deactivate only a subsequent one SPS occasion 505 or a subsequent N SPS occasions 505, the SPS release DCI deactivates all subsequent SPS occasions 505 for a given SPS configuration for the UE until the given SPS configuration is activated again by a new SPS activation DCI.

As indicated above, FIG. 5 is provided as an example. Other examples may differ from what is described with respect to FIG. 5.

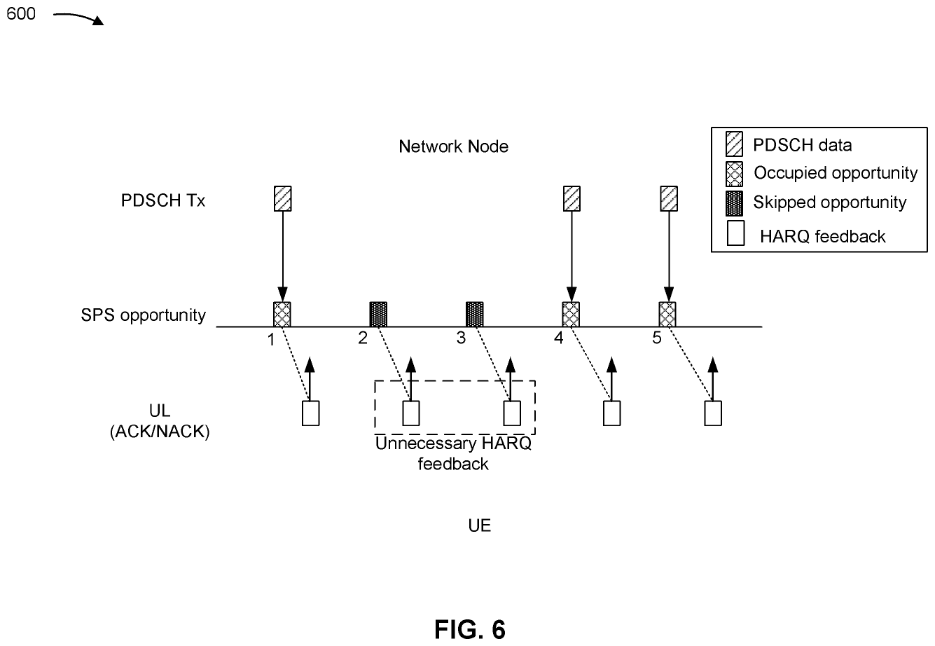

FIG. 6 is a diagram illustrating an example 600 of SPS communication, in accordance with the present disclosure.

As shown in FIG. 6, a network node may transmit a PDSCH transmission in a subset of SPS opportunities. For example, a network node may transmit a PDSCH transmission in a first SPS opportunity, may skip PDSCH transmission in a second SPS opportunity and a third SPS opportunity, and may transmit a PDSCH transmission in a fourth SPS opportunity and a fifth SPS opportunity. The first, fourth, and fifth SPS opportunities, in this case, may be referred to as “occupied opportunities” or “occupied SPS opportunities.” Similarly, the second and third SPS opportunities, in this case, may be referred to as “skipped opportunities” or “skipped SPS opportunities.”

As further shown in FIG. 6, a UE may be configured to transmit an uplink communication as a response to a PDSCH transmission. For example, the UE may be configured to transmit a hybrid automatic feedback request (HARQ) acknowledgment (ACK) or a HARQ negative acknowledgment (NACK) to indicate whether the UE has successfully received a PDSCH transmission. For the first, fourth, and fifth SPS opportunities, in this case, there may be PDSCH transmissions for which to transmit an uplink communication. The UE may transmit a HARQ ACK to indicate a successful receipt of a PDSCH transmission or a HARQ NACK to indicate a failure to successfully receive a PDSCH transmission. Based at least in part on receiving HARQ NACK feedback, the network node may retransmit a PDSCH transmission corresponding to the HARQ NACK feedback.

However, for the second and third SPS opportunities, there is no PDSCH transmission to attempt to receive and for which to transmit HARQ feedback. Accordingly, attempting to blind decode a PDSCH transmission in the second and third SPS opportunities may result in unnecessary power consumption by the UE. Moreover, the UE will fail to successfully receive a PDSCH transmission in the second and third SPS opportunities (as none was transmitted), resulting in the UE transmitting HARQ NACK feedback. However, the HARQ NACK feedback is an unnecessary utilization of network resources, as the network node does not need to receive HARQ NACK feedback (as there was no PDSCH transmission for which the HARQ NACK feedback is to trigger a retransmission).

As indicated above, FIG. 6 is provided as an example. Other examples may differ from what is described with respect to FIG. 6.

Some aspects described herein enable SPS opportunity skipping. For example, a network node may transmit, to a UE, information identifying a skip of an upcoming SPS opportunity. In this case, the UE may monitor one or more SPS opportunities, other than the skipped upcoming SPS opportunity, and may refrain from monitoring for, for example, a PDSCH in the skipped upcoming SPS opportunity. In this way, the UE reduces a utilization of power resources associated with attempting to receive and blind decode in an SPS opportunity where the network node has refrained from transmitting an SPS transmission. Moreover, the UE may refrain from transmitting HARQ feedback associated with the skipped upcoming SPS opportunity based at least in part on receiving the information identifying the skip of the upcoming SPS opportunity. In this way, the UE and the network node reduce a utilization of network resources relative to the UE transmitting HARQ feedback unnecessarily, as described above.

FIGS. 7A and 7B are diagrams illustrating an example 700 associated with downlink SPS opportunity skipping, in accordance with the present disclosure. As shown in FIG. 7A, example 700 includes communication between a network node 110 and a UE 120.

As further shown in FIG. 7A, and by reference numbers 710 and 720, the UE 120 may receive information identifying a set of SPS opportunities and information identifying a skip of an upcoming SPS opportunity. For example, the UE 120 may receive, from the network node 110, first signaling configuring a set of SPS opportunities with a configured periodicity. In this case, the UE 120 may receive, from the network node 110, second signaling identifying a skip of one or more SPS opportunities that were configured via the first signaling.

In some aspects, the UE 120 may receive the information identifying the skip of the upcoming SPS opportunity via DCI. For example, the network node 110 may transmit a modified preemption DCI, such as a DCI format 2_1 (e.g., a preemption PDCCH). In this case, the network node 110 may configure the UE 120 to monitor the DCI format 2_1 scrambled by a radio network temporary identifier (RNTI) and a control resource set (CORESET) used for an SPS activation DCI RNTI (e.g., after the UE 120 has already received an SPS activation DCI associated with the SPS activation DCI RNTI). Additionally, or alternatively, the network node 110 may configure the UE 120 to monitor the DCI format 2_1 scrambled by a dedicated RNTI and/or CORESET (e.g., dedicated for cancellation or skipping of an SPS opportunity). DCI format 2_1 may have a variable size and the network node, in some aspects, may include information in DCI indicating how the UE 120 is to interpret the DCI format 2_1. For example, the network node 110 may indicate a portion of a payload of the DCI that is to indicate one or more cancelled PDSCHs associated with one or more SPS opportunities. In some aspects, the network node 110 may include an indicator of how to interpret the DCI format 2_1 based at least in part on a size or quantity of PDSCHs that are to be cancelled.

In some aspects, the network node 110 may include a set of bits to indicate, in DCI, which SPS opportunity is to be skipped. For example, the network node 110 may include an indication of an RNTI or CORESET for each group of SPS configurations that are subject to a skip. Additionally, or alternatively, the network node 110 may configure a set of bits to indicate which SPS configurations or indices are subject to the skip and/or which occasions within an SPS configuration are being skipped. In some aspects, the network node 110 may include the indicator of a selected SPS occasion (e.g., the DCI may include an identifier of a kth SPS occasion to be skipped). Additionally, or alternatively, the UE 120 may identify an SPS occasion to be skipped based at least in part on in which SPS occasion the DCI is received on. In this case, the network node 110 may indicate a skipped SPS occasion using a last non-skipped SPS occasion. For example, as shown in FIG. 7B and by diagram 750, the network node 110 may include DCI in a kth SPS occasion to indicate that the UE 120 is to skip a k+1th SPS occasion (or some other configured constant value). Additionally, or alternatively, the UE 120 may receive information identifying a set of skipped SPS occasions and/or a set of non-skipped SPS occasions. For example, as shown in FIG. 7B and by diagram 760, the UE 120 may receive a bitmap including a first set of bits (e.g., ‘0’s) indicating skipped SPS occasions and a second set of bits (e.g., ‘1’s) indicating non-skipped SPS occasions. In this case, the UE 120 may have a default behavior for SPS occasions not subject to the bitmap (e.g., an SPS occasion after a last SPS occasion indicated with the bitmap), such as monitoring the SPS occasions not subject to the bitmap (e.g., to attempt to receive a new bitmap) by default.

In some aspects, the network node 110 may indicate skipped SPS occasions to a set of UEs 120. For example, the network node 110 may transmit a group-common DCI to a set of UEs 120 identifying one or more skipped SPS occasions associated with one or more SPS configurations for the set of UEs 120. In some aspects, the network node 110 may use a demodulation reference signal (DMRS) to indicate whether a PDSCH is being transmitted in an SPS occasion. For example, the UE 120 may attempt to receive a DMRS and may determine whether a PDSCH is present or is skipped based at least in part on attempting to receive the DMRS. In this case, the network node 110 may configure the UE 120 with a reference signal received power (RSRP) threshold (e.g., via RRC, MAC CE, or layer 1 (DCI) signaling)) that, if exceeded by the DMRS, indicates the presence of a PDSCH. In this case, if the DMRS threshold is not exceeded, the UE 120 may determine that the PDSCH is skipped and may forgo decoding of the PDSCH, but may transmit HARQ feedback for the PDSCH. The HARQ feedback may include a HARQ NACK or an indication that the UE 120 did not detect a DMRS with an RSRP that exceeded the RSRP threshold (e.g., which may enable the network node to determine whether to retransmit a PDSCH or change a beam blocking configuration in, for example, FR2). In some aspects, the UE 120 may transmit the HARQ feedback using a cyclic shift to indicate HARQ feedback other than a HARQ ACK or HARQ NACK (e.g., a cyclic shift for indicating a failure to detect a DMRS with an RSRP that exceeds the RSRP threshold). In some aspects, the RSRP threshold (or another channel threshold) may be based at least in part on a priority or quality of service (QOS) associated with the PDSCH.

As further shown in FIG. 7A, and by reference numbers, 730-1 through 730-5, the UE 120 may monitor a first one or more SPS opportunities and refrain from monitoring a second one or more SPS opportunities. For example, the UE 120 may monitor non-skipped SPS opportunities (e.g., not identified by the second signaling as being subject to the skip) and may refrain from monitoring skipped SPS opportunities (e.g., identified by the second signaling as being subject to the skip).

In some aspects, when the UE 120 is refraining from monitoring a skipped SPS opportunity, the UE 120 may forgo an attempt to receive and/or decode a configured SPS transmission (e.g., a PDSCH message or a PDCCH message) in a set of resources associated with the skipped SPS opportunity. Additionally, or alternatively, the UE 120 may transition to a reduced power state to conserve power resources during and/or proximate to the skipped SPS opportunity. In some aspects, the UE 120 may attempt to perform another communication action during the skipped SPS opportunity. For example, the UE 120 may receive another communication (e.g., from the network node 110 or another wireless communication device) or transmit another communication (e.g., to the network node 110 or another wireless communication device) during the skipped SPS opportunity. Similarly, the network node 110 may use the skipped SPS opportunity to communicate with the UE 120 (e.g., receiving from the UE 120 or transmitting information other than the configured SPS communication to the UE 120) or with another UE 120. In some aspects, the UE 120 may transmit HARQ feedback associated with the non-skipped SPS opportunities.

As indicated above, FIGS. 7A and 7B is provided as an example. Other examples may differ from what is described with respect to FIGS. 7A and 7B.

FIG. 8 is a diagram illustrating an example process 800 performed, for example, by a UE, in accordance with the present disclosure. Example process 800 is an example where the UE (e.g., UE 120) performs operations associated with downlink SPS opportunity skipping.

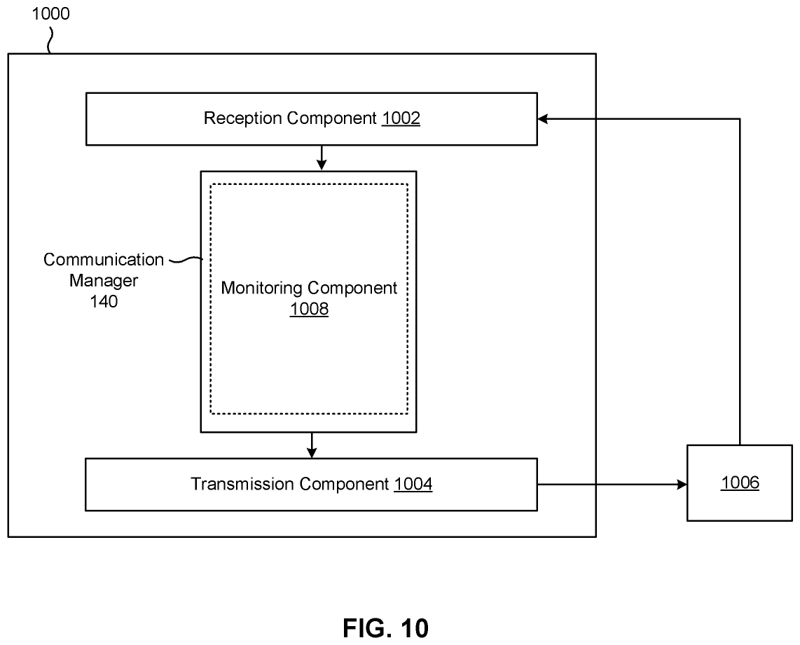

As shown in FIG. 8, in some aspects, process 800 may include receiving information indicating a skip of an upcoming SPS opportunity, of a set of configured SPS opportunities (block 810). For example, the UE (e.g., using communication manager 140 and/or reception component 1002, depicted in FIG. 10) may receive information indicating a skip of an upcoming SPS opportunity, of a set of configured SPS opportunities, as described above.

As further shown in FIG. 8, in some aspects, process 800 may include monitoring one or more SPS opportunities, of the set of SPS opportunities, other than the upcoming SPS opportunity based at least in part on receiving the information (block 820). For example, the UE (e.g., using communication manager 140 and/or monitoring component 1008, depicted in FIG. 10) may monitor one or more SPS opportunities, of the set of SPS opportunities, other than the upcoming SPS opportunity based at least in part on receiving the information, as described above.

Process 800 may include additional aspects, such as any single aspect or any combination of aspects described below and/or in connection with one or more other processes described elsewhere herein.

In a first aspect, the information includes DCI.

In a second aspect, alone or in combination with the first aspect, the DCI is associated with DCI format 2_1 associated with a radio network temporary identifier or a control resource set configured for SPS activation or cancellation.

In a third aspect, alone or in combination with one or more of the first and second aspects, the DCI includes a first portion with a first indicator and a second portion with one or more second indicators, wherein the first indicator identifies a location of the one or more second indicators in the second portion.

In a fourth aspect, alone or in combination with one or more of the first through third aspects, the DCI conveys information identifying one or more identifiers of the upcoming SPS opportunity.

In a fifth aspect, alone or in combination with one or more of the first through fourth aspects, the DCI is a group-common DCI that is associated with indicating skips of one or more upcoming SPS opportunities associated with one or more SPS configurations for one or more UEs.

In a sixth aspect, alone or in combination with one or more of the first through fifth aspects, the DCI identifies at least one of the one or more SPS opportunities, wherein an identification of the upcoming SPS opportunity is based at least in part on an identification of the at least one of the one or more SPS opportunities.

In a seventh aspect, alone or in combination with one or more of the first through sixth aspects, the DCI includes a bitmap associated with identifying the upcoming SPS opportunity.

In an eighth aspect, alone or in combination with one or more of the first through seventh aspects, monitoring the one or more SPS opportunities comprises monitoring a particular SPS opportunity occurring after a last indicated skipped SPS opportunity of a set of indicated skipped SPS opportunities.

In a ninth aspect, alone or in combination with one or more of the first through eighth aspects, the information includes a demodulation reference signal with a reference signal received power less than a configured threshold.

In a tenth aspect, alone or in combination with one or more of the first through ninth aspects, the configured threshold is based at least in part on a channel prioritization or a quality of service.

In an eleventh aspect, alone or in combination with one or more of the first through tenth aspects, process 800 includes receiving information identifying the configured threshold via at least one of a radio resource control message, a MAC CE, or DCI.

In a twelfth aspect, alone or in combination with one or more of the first through eleventh aspects, process 800 includes transmitting feedback information based at least in part on the demodulation reference signal with the reference signal received power less than the configured threshold.

In a thirteenth aspect, alone or in combination with one or more of the first through twelfth aspects, the feedback information is HARQ feedback information with a dedicated cyclic shift.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with downlink SPS opportunity skipping.

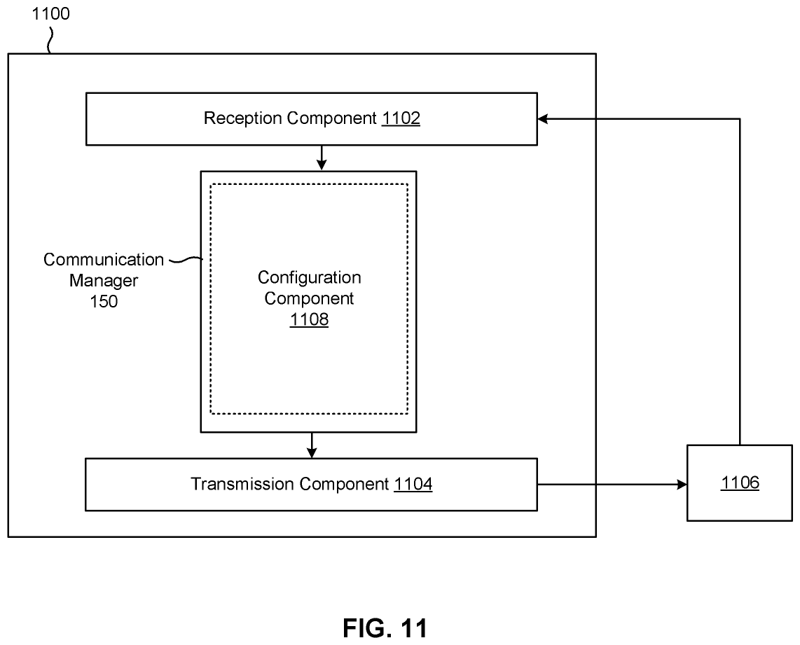

As shown in FIG. 9, in some aspects, process 900 may include transmitting, to a UE, information indicating a skip of an upcoming SPS opportunity, of a set of configured SPS opportunities (block 910). For example, the network node (e.g., using communication manager 150 and/or transmission component 1104, depicted in FIG. 11) may transmit, to a UE, information indicating a skip of an upcoming SPS opportunity, of a set of configured SPS opportunities, as described above.

As further shown in FIG. 9, in some aspects, process 900 may include transmitting, in one or more SPS opportunities, of the set of SPS opportunities, other than the upcoming SPS opportunity based at least in part on transmitting the information (block 920). For example, the network node (e.g., using communication manager 150 and/or transmission component 1104, depicted in FIG. 11) may transmit, in one or more SPS opportunities, of the set of SPS opportunities, other than the upcoming SPS opportunity based at least in part on transmitting the information, as described above.

Process 900 may include additional aspects, such as any single aspect or any combination of aspects described below and/or in connection with one or more other processes described elsewhere herein.

In a first aspect, the information includes DCI.

In a second aspect, alone or in combination with the first aspect, the DCI is associated with DCI format 2_1 associated with a radio network temporary identifier or a control resource set configured for SPS activation or cancellation.

In a third aspect, alone or in combination with one or more of the first and second aspects, the DCI includes a first portion with a first indicator and a second portion with one or more second indicators, wherein the first indicator identifies a location of the one or more second indicators in the second portion.

In a fourth aspect, alone or in combination with one or more of the first through third aspects, the DCI conveys information identifying one or more identifiers of the upcoming SPS opportunity.

In a fifth aspect, alone or in combination with one or more of the first through fourth aspects, the DCI is a group-common DCI that is associated with indicating skips of one or more upcoming SPS opportunities associated with one or more SPS configurations for one or more UEs.

In a sixth aspect, alone or in combination with one or more of the first through fifth aspects, the DCI identifies at least one of the one or more SPS opportunities, wherein an identification of the upcoming SPS opportunity is based at least in part on an identification of the at least one of the one or more SPS opportunities.

In a seventh aspect, alone or in combination with one or more of the first through sixth aspects, the DCI includes a bitmap associated with identifying the upcoming SPS opportunity.

In an eighth aspect, alone or in combination with one or more of the first through seventh aspects, monitoring the one or more SPS opportunities comprises monitoring a particular SPS opportunity occurring after a last indicated skipped SPS opportunity of a set of indicated skipped SPS opportunities.

In a ninth aspect, alone or in combination with one or more of the first through eighth aspects, the information includes a demodulation reference signal with a reference signal received power less than a configured threshold.

In a tenth aspect, alone or in combination with one or more of the first through ninth aspects, the configured threshold is based at least in part on a channel prioritization or a quality of service.

In an eleventh aspect, alone or in combination with one or more of the first through tenth aspects, process 900 includes transmitting information identifying the configured threshold via at least one of a radio resource control message, a MAC CE, or DCI.

In a twelfth aspect, alone or in combination with one or more of the first through eleventh aspects, process 900 includes receiving feedback information based at least in part on the demodulation reference signal with the reference signal received power less than the configured threshold.

In a thirteenth aspect, alone or in combination with one or more of the first through twelfth aspects, the feedback information is HARQ feedback information with a dedicated cyclic shift.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a monitoring component 1008, among other examples.

In some aspects, the apparatus 1000 may be configured to perform one or more operations described herein in connection with FIGS. 7A-7B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive information indicating a skip of an upcoming SPS opportunity, of a set of configured SPS opportunities. The monitoring component 1008 may monitor one or more SPS opportunities, of the set of SPS opportunities, other than the upcoming SPS opportunity based at least in part on receiving the information. The reception component 1002 may receive information identifying the configured threshold via at least one of a radio resource control message, a MAC CE, or DCI. The transmission component 1004 may transmit feedback information based at least in part on the demodulation reference signal with the reference signal received power less than the configured threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include one or more of a configuration component 1108, among other examples.

In some aspects, the apparatus 1100 may be configured to perform one or more operations described herein in connection with FIGS. 7A-7B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit, to a UE, information indicating a skip of an upcoming SPS opportunity, of a set of configured SPS opportunities. The transmission component 1104 may transmit, in one or more SPS opportunities, of the set of SPS opportunities, other than the upcoming SPS opportunity based at least in part on transmitting the information. The transmission component 1104 may transmit information identifying the configured threshold via at least one of a radio resource control message, a MAC CE, or DCI. The reception component 1102 may receive feedback information based at least in part on the demodulation reference signal with the reference signal received power less than the configured threshold. Configuration component 1108 may configure skipping of one or more SPS opportunities.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a UE, comprising: receiving information indicating a skip of an upcoming semi-persistent scheduling (SPS) opportunity, of a set of configured SPS opportunities; and monitoring one or more SPS opportunities, of the set of SPS opportunities, other than the upcoming SPS opportunity based at least in part on receiving the information.
Aspect 2: The method of Aspect 1, wherein the information includes downlink control information (DCI).
Aspect 3: The method of Aspect 2, wherein the DCI is associated with DCI format 2_1 associated with a radio network temporary identifier or a control resource set configured for SPS activation or cancellation.
Aspect 4: The method of any of Aspects 2 to 3, wherein the DCI includes a first portion with a first indicator and a second portion with one or more second indicators, wherein the first indicator identifies a location of the one or more second indicators in the second portion.
Aspect 5: The method of any of Aspects 2 to 4, wherein the DCI conveys information identifying one or more identifiers of the upcoming SPS opportunity.
Aspect 6: The method of any of Aspects 2 to 5, wherein the DCI is a group-common DCI that is associated with indicating skips of one or more upcoming SPS opportunities associated with one or more SPS configurations for one or more UEs.
Aspect 7: The method of any of Aspects 2 to 6, wherein the DCI identifies at least one of the one or more SPS opportunities, wherein an identification of the upcoming SPS opportunity is based at least in part on an identification of the at least one of the one or more SPS opportunities.
Aspect 8: The method of any of Aspects 2 to 7, wherein the DCI includes a bitmap associated with identifying the upcoming SPS opportunity.
Aspect 9: The method of any of Aspects 2 to 8, wherein monitoring the one or more SPS opportunities comprises: monitoring a particular SPS opportunity occurring after a last indicated skipped SPS opportunity of a set of indicated skipped SPS opportunities.
Aspect 10: The method of any of Aspects 1 to 9, wherein the information includes a demodulation reference signal with a reference signal received power less than a configured threshold.
Aspect 11: The method of Aspect 10, wherein the configured threshold is based at least in part on a channel prioritization or a quality of service.
Aspect 12: The method of any of Aspects 10 to 11, further comprising: receiving information identifying the configured threshold via at least one of: a radio resource control message, a medium access control (MAC) control element (CE), or downlink control information.
Aspect 13: The method of any of Aspects 10 to 12, further comprising: transmitting feedback information based at least in part on the demodulation reference signal with the reference signal received power less than the configured threshold.
Aspect 14: The method of Aspect 13, wherein the feedback information is hybrid automatic repeat request (HARQ) feedback information with a dedicated cyclic shift.
Aspect 15: A method of wireless communication performed by a network node, comprising: transmitting, to a user equipment (UE), information indicating a skip of an upcoming semi-persistent scheduling (SPS) opportunity, of a set of configured SPS opportunities; and transmitting, in one or more SPS opportunities, of the set of SPS opportunities, other than the upcoming SPS opportunity based at least in part on transmitting the information.
Aspect 16: The method of Aspect 15, wherein the information includes downlink control information (DCI).
Aspect 17: The method of Aspect 16, wherein the DCI is associated with DCI format 2_1 associated with a radio network temporary identifier or a control resource set configured for SPS activation or cancellation.
Aspect 18: The method of any of Aspects 16 to 17, wherein the DCI includes a first portion with a first indicator and a second portion with one or more second indicators, wherein the first indicator identifies a location of the one or more second indicators in the second portion.
Aspect 19: The method of any of Aspects 16 to 18, wherein the DCI conveys information identifying one or more identifiers of the upcoming SPS opportunity.
Aspect 20: The method of any of Aspects 16 to 19, wherein the DCI is a group-common DCI that is associated with indicating skips of one or more upcoming SPS opportunities associated with one or more SPS configurations for one or more UEs.
Aspect 21: The method of any of Aspects 16 to 20, wherein the DCI identifies at least one of the one or more SPS opportunities, wherein an identification of the upcoming SPS opportunity is based at least in part on an identification of the at least one of the one or more SPS opportunities.
Aspect 22: The method of any of Aspects 16 to 21, wherein the DCI includes a bitmap associated with identifying the upcoming SPS opportunity.
Aspect 23: The method of any of Aspects 16 to 22, wherein monitoring the one or more SPS opportunities comprises: monitoring a particular SPS opportunity occurring after a last indicated skipped SPS opportunity of a set of indicated skipped SPS opportunities.
Aspect 24: The method of any of Aspects 15 to 24, wherein the information includes a demodulation reference signal with a reference signal received power less than a configured threshold.
Aspect 25: The method of Aspect 24, wherein the configured threshold is based at least in part on a channel prioritization or a quality of service.
Aspect 26: The method of any of Aspects 24 to 25, further comprising: transmitting information identifying the configured threshold via at least one of: a radio resource control message, a medium access control (MAC) control element (CE), or downlink control information.
Aspect 27: The method of any of Aspects 24 to 26, The method of Aspect 10 further comprising: receiving feedback information based at least in part on the demodulation reference signal with the reference signal received power less than the configured threshold.
Aspect 28: The method of Aspect 27, wherein the feedback information is hybrid automatic repeat request (HARQ) feedback information with a dedicated cyclic shift.
Aspect 29: An apparatus for wireless communication at a device, comprising a processor; memory coupled with the processor; and instructions stored in the memory and executable by the processor to cause the apparatus to perform the method of one or more of Aspects 1-14.
Aspect 30: A device for wireless communication, comprising a memory and one or more processors coupled to the memory, the one or more processors configured to perform the method of one or more of Aspects 1-14.
Aspect 31: An apparatus for wireless communication, comprising at least one means for performing the method of one or more of Aspects 1-14.
Aspect 32: A non-transitory computer-readable medium storing code for wireless communication, the code comprising instructions executable by a processor to perform the method of one or more of Aspects 1-14.
Aspect 33: A non-transitory computer-readable medium storing a set of instructions for wireless communication, the set of instructions comprising one or more instructions that, when executed by one or more processors of a device, cause the device to perform the method of one or more of Aspects 1-14.
Aspect 34: An apparatus for wireless communication at a device, comprising a processor; memory coupled with the processor; and instructions stored in the memory and executable by the processor to cause the apparatus to perform the method of one or more of Aspects 15-28.
Aspect 35: A device for wireless communication, comprising a memory and one or more processors coupled to the memory, the one or more processors configured to perform the method of one or more of Aspects 15-28.
Aspect 36: An apparatus for wireless communication, comprising at least one means for performing the method of one or more of Aspects 15-28.
Aspect 37: A non-transitory computer-readable medium storing code for wireless communication, the code comprising instructions executable by a processor to perform the method of one or more of Aspects 15-28.
Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive information indicating a skip of an upcoming semi-persistent scheduling (SPS) opportunity, of a set of configured SPS opportunities; and
monitor one or more SPS opportunities, of the set of SPS opportunities, other than the upcoming SPS opportunity based at least in part on receiving the information.

2. The UE of claim 1, wherein the information includes downlink control information (DCI).

3. The UE of claim 2, wherein the DCI is associated with DCI format 2_1 associated with a radio network temporary identifier or a control resource set configured for SPS activation or cancellation.

4. The UE of claim 2, wherein the DCI includes a first portion with a first indicator and a second portion with one or more second indicators,
wherein the first indicator identifies a location of the one or more second indicators in the second portion.

5. The UE of claim 2, wherein the DCI conveys information identifying one or more identifiers of the upcoming SPS opportunity.

6. The UE of claim 2, wherein the DCI is a group-common DCI that is associated with indicating skips of one or more upcoming SPS opportunities associated with one or more SPS configurations for one or more UEs.

7. The UE of claim 2, wherein the DCI identifies at least one of the one or more SPS opportunities, wherein an identification of the upcoming SPS opportunity is based at least in part on an identification of the at least one of the one or more SPS opportunities.

8. The UE of claim 2, wherein the DCI includes a bitmap associated with identifying the upcoming SPS opportunity.

9. The UE of claim 2, wherein the one or more processors, to monitor the one or more SPS opportunities, are configured to:
monitor a particular SPS opportunity occurring after a last indicated skipped SPS opportunity of a set of indicated skipped SPS opportunities.

10. The UE of claim 1, wherein the information includes a demodulation reference signal with a reference signal received power less than a configured threshold.

11. The UE of claim 10, wherein the configured threshold is based at least in part on a channel prioritization or a quality of service.

12. The UE of claim 10, wherein the one or more processors are further configured to:
receive information identifying the configured threshold via at least one of:
a radio resource control message,
a medium access control (MAC) control element (CE), or
downlink control information.

13. The UE of claim 10, wherein the one or more processors are further configured to:
transmit feedback information based at least in part on the demodulation reference signal with the reference signal received power less than the configured threshold.

14. The UE of claim 13, wherein the feedback information is hybrid automatic repeat request (HARQ) feedback information with a dedicated cyclic shift.

15. A network node for wireless communication, comprising:
a memory; and
one or more processors, coupled to the memory, configured to:
transmit, to a user equipment (UE), information indicating a skip of an upcoming semi-persistent scheduling (SPS) opportunity, of a set of configured SPS opportunities; and
transmit, in one or more SPS opportunities, of the set of SPS opportunities, other than the upcoming SPS opportunity based at least in part on transmitting the information.

16. The network node of claim 15, wherein the information includes downlink control information (DCI).

17. The network node of claim 16, wherein the DCI is associated with DCI format 2_1 associated with a radio network temporary identifier or a control resource set configured for SPS activation or cancellation.

18. The network node of claim 16, wherein the DCI includes a first portion with a first indicator and a second portion with one or more second indicators,
wherein the first indicator identifies a location of the one or more second indicators in the second portion.

19. The network node of claim 16, wherein the DCI conveys information identifying one or more identifiers of the upcoming SPS opportunity.

20. The network node of claim 16, wherein the DCI is a group-common DCI that is associated with indicating skips of one or more upcoming SPS opportunities associated with one or more SPS configurations for one or more UEs.

21. The network node of claim 16, wherein the DCI identifies at least one of the one or more SPS opportunities, wherein an identification of the upcoming SPS opportunity is based at least in part on an identification of the at least one of the one or more SPS opportunities.

22. The network node of claim 16, wherein the DCI includes a bitmap associated with identifying the upcoming SPS opportunity.

23. The network node of claim 16, wherein the one or more processors, to monitor the one or more SPS opportunities, are configured to:
monitor a particular SPS opportunity occurring after a last indicated skipped SPS opportunity of a set of indicated skipped SPS opportunities.

24. The network node of claim 15, wherein the information includes a demodulation reference signal with a reference signal received power less than a configured threshold.

25. The network node of claim 24, wherein the configured threshold is based at least in part on a channel prioritization or a quality of service.

26. The network node of claim 24, wherein the one or more processors are further configured to:
transmit information identifying the configured threshold via at least one of:
a radio resource control message,
a medium access control (MAC) control element (CE), or
downlink control information.

27. The network node of claim 24, wherein the one or more processors are further configured to:
receive feedback information based at least in part on the demodulation reference signal with the reference signal received power less than the configured threshold.

28. The network node of claim 27, wherein the feedback information is hybrid automatic repeat request (HARQ) feedback information with a dedicated cyclic shift.

29. A method of wireless communication performed by a user equipment (UE), comprising:
receiving information indicating a skip of an upcoming semi-persistent scheduling (SPS) opportunity, of a set of configured SPS opportunities; and
monitoring one or more SPS opportunities, of the set of SPS opportunities, other than the upcoming SPS opportunity based at least in part on receiving the information.

30. A method of wireless communication performed by a network node, comprising:
transmitting, to a user equipment (UE), information indicating a skip of an upcoming semi-persistent scheduling (SPS) opportunity, of a set of configured SPS opportunities; and
transmitting, in one or more SPS opportunities, of the set of SPS opportunities, other than the upcoming SPS opportunity based at least in part on transmitting the information.
